(19) United States
(12) Patent Application Publication
(10) Pub. No.: US 2018/0360045 A1
(43) Pub. Date: Dec. 20, 2018

(54) PESTICIDE FORMULATION

(71) Applicants: Dow Global Technologies LLC, Midland, MI (US); Rohm and Haas Company, Philadelphia, PA (US)

(72) Inventors: Wei Lu, Shanghai (CN); Ling Zhong, Shanghai (CN); Jianhai Mu, Shanghai (CN); Jing Ji, Shanghai (CN); Hao Hu, Shanghai (CN)

(73) Assignees: Dow Global Technologies LLC, Midland, MI (US); Rohm and Haas Company, Philadelphia, PA (US)

(21) Appl. No.: 16/060,491

(22) PCT Filed: Dec. 11, 2015
(86) PCT No.: PCT/CN2015/097159

§ 371 Date: Jun. 8, 2018

(51) Int. Cl. A01N 47/14; A01N 25/24; A01N 25/04

(52) U.S. Cl. CPC A01N 47/14; C08L 25/14; A01N 25/04; A01N 25/24

(57) ABSTRACT

A pesticide formulation with an enhanced rain fastness performance property including (a) a pesticide composition; and (b) a latex binder adjuvant; wherein the latex binder adjuvant has a Tg value in the range of from about −30° C. to about 55° C.; wherein the latex binder adjuvant can be used in a dosage in the range of from about 2 weight percent to about 5 weight percent in the pesticide formulation to increase the rain fastness performance property of the pesticide formulation; and wherein the rain fastness performance property of the pesticide formulation can be in the range of from about 5 percent to about 90 percent; and a process for preparing the above pesticide formulation.

### FIELD

The present invention is related to a pesticide formulation and more specifically to a pesticide formulation including a latex binder adjuvant imparting an enhanced rain fastness performance property to the pesticide formulation.

### BACKGROUND

In tropical areas like South East Asia, a pesticide formulation that exhibits an increased rain fastness performance is a pressing need for users who apply pesticide formulations to plants and foliage, especially for a long-uptake pesticide with foliar applications. Although there have been some solutions to the above long-uptake pesticide problem, a negative effect with use of the known pesticide formulations still occurs. The industry desires: (1) a long-lasting rainfall resistance to retain pesticide onto a plant; (2) a good rain fastness performance balanced with good pesticide efficacy; and (3) a stable system for applications such for use in in-can formulations.

To address the above issues facing the industry, it will be necessary to incorporate an effective latex sticker into a pesticide formulation. For example, required features of an effective latex sticker should include: proper type, proper incorporation dosage, and proper Tg value; and the benefits resulting from the use of the latex sticker should include at least the following: (1) a strong interaction with a plant to firmly stick pesticide onto the plant; (2) a proper dosage to form many domains containing pesticide and polymer, which is water permeable without sacrificing pesticide efficacy; (3) a proper Tg value to facilitate the domains fabrication and to enhance rain fastness performance; and (4) a readily and commercially available proper latex sticker such as latex sticker products from The Dow Chemical Company. In addition, the above mature products will need to exhibit a wider tolerance and a cost effective advantage.

Heretofore, others have attempted to find a latex binder adjuvant that can impart an enhanced rain fastness performance property to a pesticide formulation such as disclosed in US20140309113A1, AU2013338432A1, WO2015083017A1, and US20050260240A1. For example, US20140309113A1 discloses a pesticide composition having improved rain fastness. The pesticide composition disclosed in US20140309113A1 includes polyethyleneimine (PEI) to improve rain fastness performance with a molecular weight of at least 750,000. AU2013338432A1 discloses polyamide and polyimide sticker adjuvants. The sticker adjuvants of AU2013338432A1 include a polyether amide or imide with at least a molecular weight of 1,000. The adjuvants of AU2013338432A1 also include a solvent and a spreading agent. The adjuvants of AU2013338432A1 are suitable as an in-can adjuvant in an emulsifiable concentrate (EC) type formulation and as a tank-mix adjuvant in a suspension concentrate (SC) type formulation. WO2015083017A1 discloses an agrochemical composition including a dithiocarbamate active and a polycarboxylate salt that provides rain fastness performance. US20050260240A1 discloses a rain-fast agrochemical composition including (a) an active and (b) a latex polymer emulsified with an in-situ crosslink hydrocarbon polymer.

None of the above references disclose an agrochemical pesticide formulation that includes an acrylic-based polymer; and none of the above references disclose a latex binder adjuvant that provides an enhanced rain fastness performance property to the pesticide formulation using a low dosage of the adjuvant.

### SUMMARY

The problems of the known pesticide composition of the prior art are addressed by the present invention. The present invention includes a latex binder employed as adjuvant that is added into a pesticide formulation directly to enhance the pesticide formulation's rain fastness performance. In addition, the latex binder adjuvant used in the present invention one or more of the following advantages: (1) may be a pure acrylic polymer and/or a styrene-acrylic polymer; (2) may have a Tg value in the range of from about −30° C. to about 55° C., wherein in the lower and in the higher temperature regions of this range does not have a positive effect on pesticide retention during rainfall; and (3) may be incorporated into the pesticide formulation at a low dosage such as from about 2 weight percent (wt %) to about 5 wt % and still the latex binder at this low dosage provides a beneficial effect on the pesticide formulation's rain fastness performance.

In one embodiment, the present invention is directed to a pesticide formulation with an enhanced rain fastness performance property including: (a) a pesticide composition; and (b) the latex binder adjuvant described above; wherein the latex binder adjuvant has a Tg value in the range of from about −30° C. to about 55° C. The latex binder adjuvant can be used in a dosage in the range of from about 2 wt % to about 5 wt % in the pesticide formulation to increase the rain fastness performance property of the pesticide formulation such that the rain fastness performance property of the pesticide formulation is in the range of from about 5 percent (%) to about 90%.

In another embodiment, the present invention is directed to a process of manufacturing the above pesticide formulation.

### BRIEF DESCRIPTION OF THE DRAWINGS

For the purpose of illustrating the present invention, the drawings show a form of the present invention which is presently preferred. However, it should be understood that the present invention is not limited to the precise arrangements and instrumentation shown in the drawings. In the drawings, like elements are referenced with like numerals. Therefore, the following drawings illustrate non-limiting embodiments of the present invention wherein:

FIG. 1A is a photograph of a series of droplets deposited on a para-film attached to the surface of a metal substrate, wherein the composition of the droplets comprises mancozeb SC

(1 wt %) containing different binder types at varying dosages of the binder types. The photograph is taken after drying the droplets on the para-film.

FIG. 1B is a photograph of the series of droplets of FIG. 1A wherein the photograph shows the dried sample of droplets after subjecting the dried droplets to a simulated rainfall spray.

FIG. 2A is a photograph of a series of droplets deposited on a para-film attached to the surface of a metal substrate, wherein the composition of the droplets comprises mancozeb SC

(1 wt %) containing the same binder types but at different Tg values and at varying dosages of the binder types. The photograph is taken after drying the droplets on the para-film.

FIG. 2B is a photograph of the series of droplets of FIG. 2A wherein the photograph shows the dried sample of droplets after subjecting the dried droplets to a simulated rainfall spray.

FIG. 3A is a photograph of a series of droplets deposited on a para-film attached to the surface of a metal substrate, wherein the composition of the droplets comprises mancozeb SC (1 wt %) containing the same binder types but at different Tg values and at varying dosages of the binder types. The photograph is taken after drying the droplets on the para-film.

FIG. 3B is a photograph of the series of droplets of FIG. 3A wherein the photograph shows the dried sample of droplets after subjecting the dried droplets to a simulated rainfall spray.

FIG. 4 is a representation of a pixel-based image showing a series of dried droplets on a substrate wherein one dried droplet (Sample 4a, which is the control) is shown before the dried droplet is subjected to a simulated rainfall spray test and three samples of dried droplets (Samples 4b-4d) after subjecting the dried droplets to a simulated rainfall spray test.

### DETAILED DESCRIPTION

In its broadest scope, the present invention includes a pesticide formulation with an enhanced rain fastness performance property; wherein the pesticide formulation includes: (a) a pesticide composition; and (b) at least one latex binder adjuvant, wherein the latex binder adjuvant has a Tg value in the range of from about 5° C. to about 30° C. The latex binder adjuvant can be used as additive or adjuvant to impart the pesticide formulation or system with an enhanced rain fastness performance property.

The latex binder adjuvant (also referred to herein as a “sticker”) is useful as an adjuvant additive for a pesticide formulation which can be added directly to the pesticide formulation to enhance the rain fastness performance of the pesticide formulation. The latex binder adjuvant may include for example one or more of the following compounds: (i) a pure acrylic latex, (ii) a hydrophobe modified derivate of an acrylic latex, (iii) a styrene-acrylic polymer, (iv) a derivative of a styrene-acrylic polymer, or (v) mixtures of two or more of the components (i) to (iv).

The latex binder adjuvant advantageously exhibits a Tg value to provide an effective pesticide formulation with only a low (e.g., less than or equal to about 10 wt %) dosage of the latex binder adjuvant in the pesticide formulation while providing the pesticide formulation with a rain fastness performance enhancement when the latex binder adjuvant is used in a pesticide formulation.

Generally, a “pure acrylic latex” used as the latex binder adjuvant is the homopolymer or co-polymer synthesized from acrylate monomers based on the structure of acrylic acid, which consists of a vinyl group and a carboxylic acid terminus. The “pure acrylic latex” may include other typical acrylate monomers such as derivatives of acrylic acid, such as methyl methacrylate, butyl acrylate, acrylonitrile and mixtures thereof.

In a more preferred embodiment, the pure acrylic latex useful in the latex binder adjuvant of the present invention may include for example, a pure acrylic or the latex binder adjuvant polymer can be prepared from one or more monomers described above.

If a hydrophobic derivative of an acrylic acid latex is used as the binder material or if hydrophobic derivative is incorporated into a pure acrylic acid, the pure acrylic acid is no longer a “pure” acrylic acid latex binder adjuvant, but instead can be considered as a “hydrophobe modified derivative”. By “hydrophobe”, “hydrophobic”, or “hydrophobicity”, with reference to the hydrophobe modified derivate of acrylic latex described above, it is meant a compound that is less dissolving in water or has an absence of attraction to water. Generally, a hydrophobe modified derivate of an acrylic latex used as the latex binder adjuvant may include for example, but not limited to, one or more oft-amyl methacrylate, n-decyl methacrylate, n-godecyl acrylate,

2-ethylhexyl acrylate, n-hexyl acrylate, n-octyl methacrylate and the like; and mixtures thereof.

In a more preferred embodiment, the hydrophobe modified derivate of acrylic latex useful in the latex binder adjuvant of the present invention may include for example, a styrene-acrylic polymer or a derivative of a styrene-acrylic polymer. A styrene-acrylic polymer is the polymer resulting from incorporating a styrene monomer into the backbone of a pure acrylic or a hydrophobe modified acrylic polymer.

The concentration of the latex binder adjuvant of the present invention may range generally from about 0.01 wt % to about 10 wt % in one embodiment, from about 0.1 wt % to about 10 wt % in another embodiment, from about 1 wt % to about 10 wt % in still another embodiment; from about 1 wt % to about 8 wt % in yet another embodiment; and from about 2 wt % to about 5 wt % in even still another embodiment, based on the total weight of the components in the pesticide formulation (e.g. including the active ingredient, adjuvant and water in the pesticide formulation). Below the range of dosage incorporation of about 0.01 wt % of the latex binder described above, the desired rain fastness performance is not achieved; and above the higher dosage of about 10 wt % would not provide better performance and the addition of more latex binder would be uneconomical.

Generally, the Tg of the latex binder adjuvant can be between about −30° C. and about 55° C. in one embodiment, between about −10° C. and about 40° C. in another embodiment, and between about 5° C. and about 30° C. in still another embodiment. Outside the ranges of the lower and higher Tg values of the latex binder adjuvant described above, will not provide the pesticide formulation to achieve a desirable rain fastness performance.

Generally, the pesticide additive or composition used for forming the final pesticide formulation may include any of the conventional pesticide products known in the art. For example, the final pesticide formulation may include various types of pesticide formulations including water borne formulations such as SC (suspension concentrate), EW (emulsion in water), ME (microemulsion), SE (suspo-emulsion), SL (soluble concentrate), CS (capsule suspension) and the like; and mixtures thereof. In a more preferred embodiment, the pesticide additive or pesticide composition useful in preparing the pesticide formulation of the present invention may include for example, a SC (suspension concentrate), an EW (emulsion in water), or mixtures thereof.

The concentration of the pesticide additive or composition used in the final pesticide formulation of the present invention may depend on the pesticide additive used, the desired specifications of a pesticide formulation components, and the formulation type used. As an illustration of one embodiment, when the pesticide additive is mancozeb (a fungicide), when the pesticide formulation type is a suspension concentrate; and when the pesticide formulation components include an active ingredient, a wetting agent, a dispersant, a defoamer, an antifreezing agent and a thickener; the concentration range of the pesticide additive is generally from about 20 wt % to about 45 wt % in one embodiment, from about 25 wt % to about 40 wt % in another embodiment, and from about 30 wt % to about 35 wt % in still another embodiment, based on the total weight of the actives of the pesticide formulation.

In the above illustration of the pesticide formulation, the latex binder adjuvant (or sticker) used for adding to the pesticide composition, formulation, or system is the latex binder adjuvant described above. The latex binder adjuvant only has to be added to the pesticide formulation in a small dosage to impart an enhanced rain fastness performance property to the pesticide formulation. For example, the latex binder dosage used in the pesticide formulation illustrated above may be generally in the range of from about 0.01 wt % to about 10 wt % in one embodiment, from about 0.1 wt % to about 7 wt % in another embodiment, and from about 2 wt % to about 5 wt % in still another embodiment, based on the total weight of the actives of the pesticide formulation.

The other optional compounds or additives such as a wetting agent, a dispersant, a defoamer, an antifreezing agent and a thickener useful in the pesticide formulation illustrated above can make up the remainder of the pesticide formulation and the concentration of such additives are adjusted accordingly.

The process used to prepare the pesticide formulation with an enhanced rain fastness performance property includes blending, admixing or mixing of the above components in conventional mixing equipment or vessels known in the art. For example, the preparation of the pesticide formulation of the present invention is achieved by blending, in known mixing equipment, the pesticide composition and the latex binder adjuvant; and optionally any other desirable additives.

The above compounds of the pesticide formulation are typically mixed and dispersed in a vessel at a temperature enabling the preparation of an effective pesticide formulation. For example, in a preferred embodiment, the temperature during the mixing of the above components may be generally at room temperature.

The preparation of the pesticide formulation of the present invention, and/or any of the steps thereof, may be a batch or a continuous process. In a preferred embodiment, the mixing process of the pesticide formulation components and the mixing equipment used in the process may be any vessel and ancillary equipment well known to those skilled in the art.

In one preferred embodiment, when preparing a pesticide formulation, for example, the concentration of the pesticide formulation in terms of per 100 parts (g) of pesticide SC, the pesticide formulation can include from about 90 parts to about 100 parts of component (a), the pesticide composition; and from about 0.01 parts to about 10 parts of component (b), the latex binder adjuvant. In another preferred embodiment, when preparing a pesticide formulation, for example per 100 parts (g) of pesticide SC, the pesticide formulation can include from about 95 parts to about 100 parts of component (a), the pesticide composition; and from about 2 parts to about 5 parts of component (b), the latex binder adjuvant.

The pesticide formulation prepared by the above process of the present invention exhibits several unexpected and unique properties. For example, one beneficial property of the pesticide formulation is its rain fastness performance. In one embodiment, the rain fastness performance property of the pesticide formulation of the present invention may be measured visually by comparing the performance results of samples of the pesticide formulation containing the latex binder adjuvant of the present invention with samples of pesticide formulation not containing the latex binder adjuvant of the present invention at the same testing conditions to provide a parallel comparison.

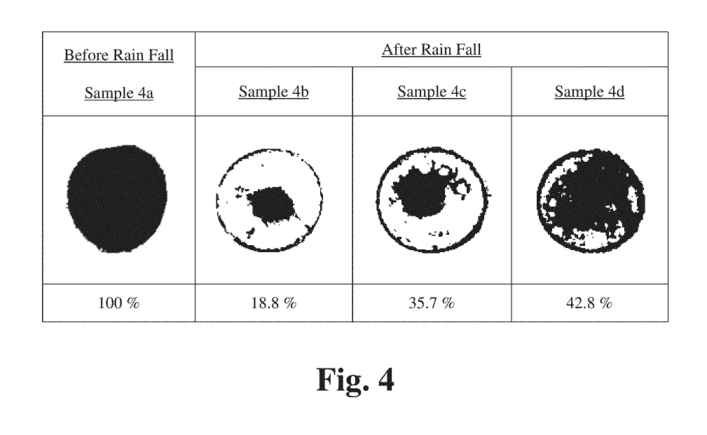

In another preferred embodiment, the rain fastness performance property of the pesticide formulation of the present invention may be measured using a semi-quantifying rain fastness method as described herein below. The method includes (1) subjecting sample droplets or spots of the pesticide formulation to a rainfall test, (2) transforming each of the sample spots of pesticide formulation into a pixel-based image in black-and-white format as shown in FIG. 4, and (3) correlating the pesticide formulation residue (i.e., the amount of pesticide formulation remaining on a substrate) of the sample spots, as shown by the pixel black and white figure, using a ratio or percentage against a pixel a control sample spot which is considered as 100% before the control sample spot is subjected to a rainfall test. In terms of a percentage, as indicated by the pixels in FIG. 4; the residue pixel of each sample spot, after rainfall washing, is compared to the sample spot's initial 100% pixel to obtain a residue ratio or percentage.

The above semi-quantitative pixel method reflects a visual difference among varied samples and the measurement using the pixel method above provides an acceptable general quantity in terms of a percentage of the remaining material in the residue pixel as illustrated in FIG. 4. Generally, the rain fastness performance property based on the above pixel method can be in the range of from about 5% to about 90% in one embodiment, from about 5% to about 85% in another embodiment, and from about 5% to about 80% in still another embodiment.

After the pesticide formulation of the present invention is prepared as described above, the pesticide formulation can be used on any foliage that needs protection. For example, the foliage can be plants, fruits, and vegetables foliage. The pesticide formulation can be used as a herbicide, a fungicide or an insecticide. In a preferred embodiment, the pesticide formulation of the present invention can be applied to the foliage at a temperature of from about 10° C. to about 40° C.

### EXAMPLES

The following Examples and Comparative Examples further illustrate the present invention in more detail but are not to be construed to limit the scope thereof.

In the following Examples and Comparative Examples, various terms and designations were used and are explained as follows:

“SC” stands for suspension concentrate.

“wt %” stands for weight percent.

“Tg” stands for glass transition temperature.

In the following Examples and Comparative Examples, the following raw materials or components described in Table I were used for preparing pesticide formulations and for evaluating the rain fastness enhancement of such pesticide formulations.

TABLE I
Raw Materials and Suppliers

| Component | Latex Type | Tg Value | Supplier |
|---|---|---|---|
| 33 wt % mancozeb SC | pesticide formulation | — | prepared in laboratory |
| Rovace ™ 662 | vinyl-acrylic latex | ~29° C. | The Dow Chemical Company |
| Dirt Shield ™ 08 | pure acrylic latex | ~12° C. | The Dow Chemical Company |
| Primal ™ AC-261P | pure acrylic latex | ~23° C. | The Dow Chemical Company |
| Primal ™ AC-268 | pure acrylic latex | ~20° C. | The Dow Chemical Company |
| Dirt Shield ™ 12 | pure acrylic latex | ~40° C. | The Dow Chemical Company. |
| Dirt Shield ™ K2 | pure acrylic latex | ~53° C. | The Dow Chemical Company |
| Elastene ™ 2471 | styrene-acrylic latex | ~20° C. | The Dow Chemical Company |
| Elastene ™ 1500 | styrene-acrylic latex | ~7° C. | The Dow Chemical Company |
| Primal ™ AS-2010 | styrene-acrylic latex | ~21° C. | The Dow Chemical Company |
| Primal ™ DC-421V | styrene-acrylic latex | ~30° C. | The Dow Chemical Company |

General Procedure for Sample Preparation

The samples of pesticide formulations prepared for rain fastness performance testing were prepared in accordance with the following steps:

Step (1): different latex binders with varied dosages were incorporated into mancozeb SC to form a fungicide formulation;

Step (2): the fungicide formulation samples were diluted to 1 wt % concentration;

Step (3): 30 μL of the diluted samples from Step (2) were dropped in droplet form, using a pipette, onto a para-film substrate to obtain sample spots (droplets) on the surface of the substrate. Three spots were prepared for each sample formulation for comparison; and

Step (4): the para-film substrate prepared above with the spots on the surface of the substrate was placed into an environmental chamber for 2 hours (hr) under 30° C. with 60% relative humidity (R.H.) to obtain dried spots.

The prepared substrate with dried spots from Step (4) above where then subjected to a rain simulation spray test to evaluate the dried spots for rain fastness performance in accordance with the following general procedure.

### General Procedure for Rain Fastness Performance Testing

The para-film substrate with the pesticide formulation spots on the top surface of the para-film substrate prepared as described above, were placed into a rain simulation chamber and sprayed for 30 minutes (min) under heavy simulated rainfall of 100 mL/hr. After the simulated rainfall was stopped, the para-film substrate with sample spots was taken out of the chamber and visually observed to check the condition of the spots so as to visually assess the rain fastness performance of the spots. The spots that had more pesticide formulation residue remaining in the spots on the substrate were visually assessed to have a better rain fastness performance than the other spots with less pesticide formulation residue remaining in the spots on the substrate.

### General Semi-Quantitative Procedure for Rain Fastness Performance Testing

As an illustration of one method of quantifying rain fastness, i.e., to semi-quantify the amount of rain fastness achieved in the present examples, each of the sample spots was transformed into a pixel-based image in black-and-white format as shown in FIG. 4. The pixel of every sample spot before subjecting the spot to the rainfall test, in terms of a percentage, was considered as 100% as indicated by the pixel 4a; and the residue pixel of each sample spot, pixels 4b-4d, after rainfall washing was compared to the each of the spot's initial 100% pixel 4a to get a residue ratio or percentage.

The above semi-quantitative pixel method reflects a visual difference among varied samples and the measurements using the above pixel method provides an acceptable general quantity in terms of a percentage of the remaining material in the residue pixel as illustrated in FIG. 4.

### Examples 1-3 and Comparative Example A: Latex Type and Dosage Effect on Rain Fastness

To verify clearly which kind of latex binder adjuvant would work well on the rain fastness performance of the pesticide formulation, the latex binder adjuvant with Tg value but different type and different dosage was incorporated into 33 wt % mancozeb SC. Generally, the vinyl-acrylic binder is more hydrophilic than other two types of binders (i.e., the pure acrylic and the styrene acrylic binders), followed by the pure acrylic type binder and then the styrene-acrylic binder which shows a more relatively hydrophobic feature among the above three binders. The pesticide formulation recipes are shown in Table II. It has been found that incorporating the latex binder adjuvant into a pesticide SC system does not damage the stability of the pesticide SC system.

TABLE II
Formulations of Different Latex Types and Dosage and Tg Value

| | | | Tg | Dosage | | | | | | | | | |
|---|---|---|---|---|---|---|---|---|---|---|---|---|---|
| Example No. | Components | Latex Type | Value | (wt %) | | | | | | | | | |
| Comparative | 33 wt % | pesticide | — | 100 | 99 | 98 | 97 | 99 | 98 | 97 | 99 | 98 | 97 |
| Example A | mancozeb SC | formulation | | | | | | | | | | | |
| Example 1 | Rovace ™ 662 | vinyl-acrylic | ~29° C. | | 1 | 2 | 3 | | | | | | |
| Example 2 | Primal ™ | pure acrylic | ~23° C. | | | | | 1 | 2 | 3 | | | |
| | AC-261P | | | | | | | | | | | | |
| Example 3 | Primal ™ | styrene- | ~21° C. | | | | | | | | 1 | 2 | 3 |
| | AS-2010 | acrylic | | | | | | | | | | | |

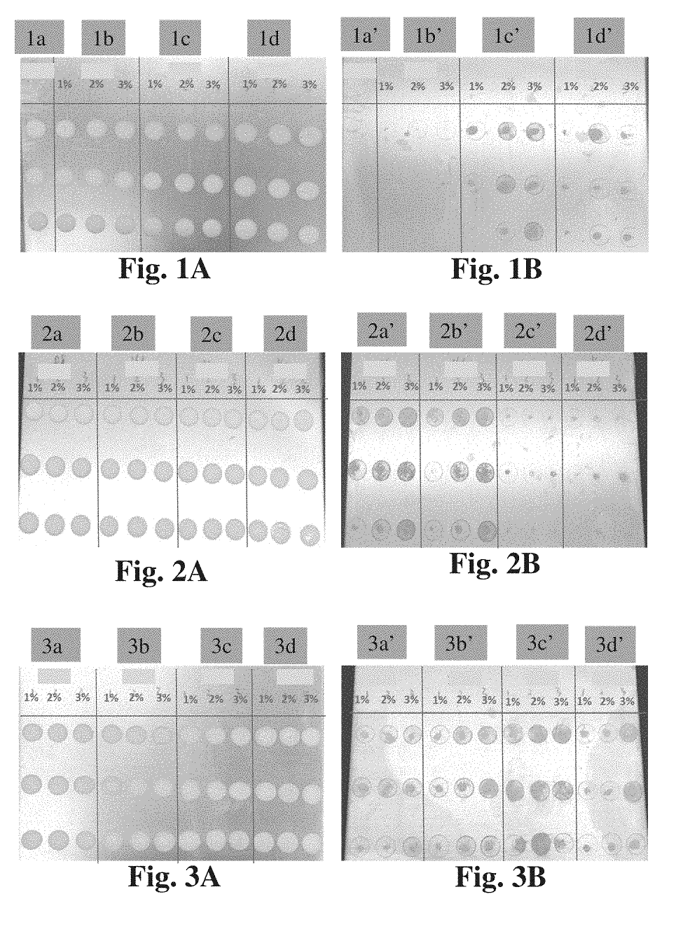

With reference to FIGS. 1A and 1B, there is shown photographs showing spots 1a-1d and spots 1a′-1d′, respectively, of pesticide formulation sample spots including mancozeb SC (1 wt %) added with different binder types and at varying dosages of binders (1 wt %, 2 wt % and 3 wt %). The photograph shown in FIG. 1A was taken after drying the spots to form spots 1a-1d; and the photograph shown in FIG. 1B was taken of the dried sample spots after the dried spots 1a-1d were subjected to a simulated rainfall spray such that spots 1a′-1d′ were formed. The cross lines shown in the Figures were inserted into the Figures to separate the various sample spots.

When the functional formulations were diluted to 1 wt %, dropped onto para-film substrate, and subjected to a drying process, the uniform sample spots were formed (FIG. 1A). These dried sample spots were sprayed under a simulated heavy rainfall of 100 ml/hr for 30 min in a rain simulation chamber. Then, the sample spots were taken out of the rain simulation chamber to observe any pesticide formulation residual that remained on the substrate. The more pesticide retention, as analyzed by visual inspection, the better rain fastness performance.

As shown in FIG. 1B, there is almost no pesticide formulation retained in the sample spot after rainfall spray (see spots 1a′, 1b′ and 1d′). And, the same situation was seen for a formulation containing a vinyl acrylic based binder (Rovace™ 662) even after increasing the dosage from 1 wt % to 3 wt %. However, for a formulation containing a pure acrylic based binder (Primal™ AC-261P), a large amount of pesticide formulation was clearly observed in the sample spot on the para-film with a 2 wt % dosage and a 3 wt % dosage (see spots 1c′). The same results were observed when a styrene-acrylic binder (Primal™ AS-2010) was incorporated in a pesticide formulation, although the pesticide retention amount for the formulation containing the styrene-acrylic binder was not as high as when using the pure acrylic (Primal™ AC-261P).

It can be concluded from the above results that the incorporation of hydrophilic binder would provide a less benefit on pesticide rain fastness enhancement than a hydrophic binder or binder that leans toward being hydrophobic than hydrophilic. On the contrary, the not so hydrophilic binder and hydrophobic binder retains more pesticide formulation under simulated rainfall spray (raining) conditions. Moreover, the 2 wt % dosage of the latex binder adjuvant had an obvious positive effect on pesticide formulation rain fastness enhancement.

### Examples 4-7 and Comparative Example B: Latex Tg Value Effect on Rain Fastness

To determine the effect of binder Tg on the rain fastness performance property of the functional pesticide formulations, several formulations were prepared by mixing 33 wt % mancozeb SC with the binders as described in Table III (Examples 4-7). A pure acrylic was used as the latex binder adjuvant as described in Table III. The latex binder adjuvant had different Tg values as described in Table III. Also, different dosages of the binder were added to the functional formulations as described in Table III.

TABLE III
Functional Formulations of Pure Acrylic Latex: Different Tg Value and Dosage

| | | Tg | Dosage | | | | | | | | | | | | |
|---|---|---|---|---|---|---|---|---|---|---|---|---|---|---|---|
| Example No. | Components | Value | (wt %) | | | | | | | | | | | | |
| Comparative | 33 wt % | — | 100 | 99 | 98 | 97 | 99 | 98 | 97 | 99 | 98 | 97 | 99 | 98 | 97 |
| Example B | mancozeb SC | | | | | | | | | | | | | | |
| Example 4 | Dirt Shield ™ 08 | ~12° C. | | 1 | 2 | 3 | | | | | | | | | |
| | (pure acrylic) | | | | | | | | | | | | | | |
| Example 5 | Primal ™ AC-268 | ~20° C. | | | | | 1 | 2 | 3 | | | | | | |
| | (pure acrylic) | | | | | | | | | | | | | | |
| Example 6 | Dirt Shield ™ 12 | ~40° C. | | | | | | | | 1 | 2 | 3 | | | |
| | (pure acrylic) | | | | | | | | | | | | | | |
| Example 7 | Dirt Shield ™ K2 | ~53° C. | | | | | | | | | | | 1 | 2 | 3 |
| | (pure acrylic) | | | | | | | | | | | | | | |

With reference to FIGS. 2A and 2B, there is shown photographs showing spots 2a-2d and spots 2a′-2d′, respectively, of pesticide formulations including mancozeb SC (1 wt %) added with same binder types but different Tg values and at varying dosages of binders. The photograph shown in FIG. 2A was taken after drying the spots to form spots 2a-2d; and the photograph shown in FIG. 2B was taken of the dried sample spots after the dried spots 2a-2d were subjected to a simulated rainfall spray such that spots 2a′-2d′ were formed. The cross lines shown in the Figures were inserted into the Figures to separate the various sample spots.

Although all of the functional formulations can form good quality sample spots after drying as shown in FIG. 2A, the distinctive difference could be seen after the sample spots were subjected to simulated rainfall spray as shown in FIG. 2B. When the binder Tg value is selected at a proper range, such as from about 12° C. to about 20° C., a large amount of pesticide formulation was retained in the sample spots even when the sample spots were subjected to harsh spray conditions. However, once the binder glass transition temperature was increased to as high as 40° C. or higher, it was observed that an extremely limited amount of pesticide formulation could be up-taken by the sample spots while undergoing a simulated rainfall spray test.

The above results demonstrate that the binder Tg value plays an important role in pesticide formulation sticking on a substrate such as foliage and that the proper Tg range of a pure acrylic type binder can be selected to be in the range of from about 12° C. to about 20° C.

### Examples 8-11 and Comparative Example C: Latex Tg Value Effect on Rain Fastness

In these examples, a styrene-acrylic was used as the latex binder adjuvant in a pesticide formulation as described in Table IV (Examples 8-11); and the binder Tg effect on the rain fastness performance of the formulation was evaluated. The formulations were prepared by mixing 33 wt % mancozeb SC with the binders described in Table IV.

TABLE IV
Functional Formulation of Styrene-Acrylic Latex: Different Tg Value and
Dosage

| | | Tg | Dosage | | | | | | | | | | | | |
|---|---|---|---|---|---|---|---|---|---|---|---|---|---|---|---|
| Example No. | Components | Value | (wt %) | | | | | | | | | | | | |
| Comparative | 33 wt % | — | 100 | 99 | 98 | 97 | 99 | 98 | 97 | 99 | 98 | 97 | 99 | 98 | 97 |
| Example C | mancozeb SC | | | | | | | | | | | | | | |
| Example 8 | Elastene ™ 2471 | ~−20° C. | | 1 | 2 | 3 | | | | | | | | | |
| | (styrene-acrylic) | | | | | | | | | | | | | | |
| Example 9 | Elastene ™ 1500 | ~7° C. | | | | | 1 | 2 | 3 | | | | | | |
| | (styrene-acrylic) | | | | | | | | | | | | | | |
| Example 10 | Primal ™ | ~21° C. | | | | | | | | 1 | 2 | 3 | | | |
| | AS-2010 | | | | | | | | | | | | | | |
| | (styrene-acrylic) | | | | | | | | | | | | | | |
| Example 11 | Primal ™ | ~30° C. | | | | | | | | | | | 1 | 2 | 3 |
| | DC-421V | | | | | | | | | | | | | | |
| | (styrene-acrylic) | | | | | | | | | | | | | | |

With reference to FIGS. 3A and 3B, there is shown photographs showing spots 3a-3d and spots 3a′-3d′, respectively, of pesticide formulations including mancozeb SC (1 wt %) added with same binder types but different Tg values and at varying dosages of binders. The photograph shown in FIG. 3A was taken after drying the spots such that spots 3a-3d were formed; and the photograph shown in FIG. 3B was taken of the dried sample spots after the dried spots 3a-3d were subjected to a simulated rainfall spray such that spots 3a′-3d′ were formed. The cross lines shown in the Figures were inserted into the Figures to separate the various sample spots.

The well-formed formulation sample spots containing a styrene-acrylic type binder are shown in FIG. 3A for the formulation sample spots containing styrene-acrylic type binder having different Tg values. When comparing the behavior of each formulation sample spot after each of the sample spots was subjected to a simulated rainfall spray test, the latex binder adjuvants: Elastene™ 1500 and Primal™ AS-2010 exhibit a greater amount of pesticide formulation residue in the sample spots. Therefore, the styrene-acrylic binder with a Tg value in the range of from about 7° C. to about 21° C. may be considered a proper latex binder adjuvant having the proper Tg for enhancing the rain fastness property of a pesticide formulation.

### Pixel Method Testing Results

The pixel method described above was used to provide an acceptable general quantity in terms of a percentage of the sample spots prepared in the Examples above. The results of the pixel method testing are described in Tables V-VII.

TABLE V

| | Sample | | | | | | | | | |
|---|---|---|---|---|---|---|---|---|---|---|
| | | 1b′ | | | 1c′ | | | 1d′ | | |
| | 1a′ | 1 wt % | 2 wt % | 3 wt % | 1 wt % | 2 wt % | 3 wt % | 1 wt % | 2 wt % | 3 wt % |
| Pesticide | 0% | 0% | 0% | 0% | 13.1% | 39.2% | 45.3% | 8.6% | 18.4% | 17.5% |
| residue ratio | | | | | | | | | | |

TABLE VI

| | Sample | | | | | | | | | | | |
|---|---|---|---|---|---|---|---|---|---|---|---|---|
| | 2a′ | | | 2b′ | | | 2c′ | | | 2d′ | | |
| | 1 wt % | 2 wt % | 3 wt % | 1 wt % | 2 wt % | 3 wt % | 1 wt % | 2 wt % | 3 wt % | 1 wt % | 2 wt % | 3 wt % |
| Pesticide | 50.1% | 61.2% | 78.5% | 10.3% | 53.7% | 72.2% | 6.6% | 5.9% | 5.1% | 5.4% | 13.1% | 11.6% |
| residue | | | | | | | | | | | | |
| ratio | | | | | | | | | | | | |

TABLE VII

| | Sample | | | | | | | | | | | |
|---|---|---|---|---|---|---|---|---|---|---|---|---|
| | 3a′ | | | 3b′ | | | 3c′ | | | 3d′ | | |
| | 1 wt % | 2 wt % | 3 wt % | 1 wt % | 2 wt % | 3 wt % | 1 wt % | 2 wt % | 3 wt % | 1 wt % | 2 wt % | 3 wt % |
| Pesticide | 31.8% | 32.5% | 44.2% | 20.1% | 40.3% | 55.1% | 52.1% | 54.3% | 59.3% | 12.7% | 16.7% | 70.1% |
| residue ratio | | | | | | | | | | | | |

In summary based on the above results, it has been found that a latex binder adjuvant of a proper predetermined type with the right predetermined Tg value, and used at the proper predetermined dosages can be utilized as an adjuvant for pesticide formulations to provide the pesticide formulations with an enhanced rain fastness performance.

1. A pesticide formulation with an enhanced rain fastness performance property comprising:
(a) a pesticide composition; and
(b) an acrylic-based latex;
wherein the acrylic-based latex has a Tg value in the range of from about −30° C. to about 55° C.

2. The formulation of claim 1, wherein the acrylic-based latex dosage is in the range of from about 0.01 weight percent to about 10 weight percent.

3. The formulation of claim 1, wherein the rain fastness performance property of the pesticide formulation is in the range of from about 5 percent to about 90 percent.

4. (canceled)

5. The formulation of claim 1, wherein the acrylic-based latex is selected from the group consisting of:
(i) a pure acrylic latex;
(ii) a styrene-acrylic latex; and
(iii) mixtures of two or more of the components (i) and (ii).

6. The formulation of claim 2, wherein the acrylic-based latex is a modified acrylic latex.

7. The formulation of claim 1, wherein the pesticide composition comprises mancozeb suspension concentrate.

8. The formulation of claim 1, wherein the dosage of the acrylic-based latex is from about 2 weight percent to about 5 weight percent.

9. The formulation of claim 1, wherein the rain fastness performance property of the pesticide formulation is in the range of from about 5 percent to about 80 percent.

10. The formulation of claim 1, wherein the formulation is used as a pesticide on plants, fruits, or vegetables.

11. A process for preparing a pesticide formulation with an enhanced rain fastness performance property comprising admixing:
(a) a pesticide composition; and
(b) a an acrylic-based latex;
wherein the acrylic-based latex has a Tg value in the range of from about −30° C. to about 55° C.

12. The process of claim 11, wherein the acrylic-based latex dosage is in the range of from about 0.01 weight percent to about 10 weight percent.

13. The process of claim 11, wherein the rain fastness performance property of the pesticide formulation is in the range of from about 5 percent to about 90 percent.

14. (canceled)

15. The process of claim 11, wherein the “an acrylic-based latex” is selected from the group consisting of:
(i) a pure acrylic latex;
(ii) a styrene-acrylic latex; and
(ii) mixtures of two or more of the components (i) and (ii).

16. The process of claim 11, wherein the acrylic-based latex is a modified acrylic latex.

17. The process of claim 11, wherein the pesticide composition comprises mancozeb suspension concentrate.

18. The process of claim 11, wherein the dosage of the acrylic-based latex is from about 2 weight percent to about 5 weight percent.

19. (canceled)

20. The process of claim 11, wherein the formulation is used as a pesticide on plants, fruits, or vegetables.

21. The process of claim 11, wherein the pesticide formulation is a fungicide, a herbicide or an insecticide.
